(19) United States
(12) Patent Application Publication
(10) Pub. No.: US 2020/0049865 A1
(43) Pub. Date: Feb. 13, 2020

(54) OPTICAL LENS AND LENS MODULE

(71) Applicant: AAC Technologies Pte. Ltd., Singapore city (SG)

(72) Inventor: Chuandong Wei, Shenzhen (CN)

(21) Appl. No.: 16/529,772

(22) Filed: Aug. 1, 2019

(30) Foreign Application Priority Data
Aug. 10, 2018 (CN) 201821294016.8

(51) Int. Cl. G02B 5/00; G02B 7/02

(52) U.S. Cl. CPC G02B 5/003; G02B 7/025

(57) ABSTRACT

The present disclosure relates to the field of optical imaging technology and more particularly to an optical lens. The optical lens includes an optical portion located at a central position and configured for optical imaging, and an abutting portion surrounding the optical portion and configured to abut against other optical components. A surface of the abutting portion is provided with a roughened area and a blackened area. The optical lens can effectively weaken the reflected stray light incident thereon and improve the imaging quality of a lens module.

### TECHNICAL FIELD

The present disclosure relate to the field of optical imaging technology, and in particular, to an optical lens used in a lens module in an electronic device such as a camera, a video camera, a mobile phone, a tablet computer, and a notebook computer.

### BACKGROUND

In recent years, with the development of the imaging technology and the rise of electronic products with imaging functions, optical lens modules have been widely used in various products and have been continuously improved and optimized. At present, the improvement direction of most lens modules lies in how to make the lens module smaller and thinner, how to select suitable lenses with good optical characteristic compatibility while making the lens module smaller and thinner, and how to combine the lenses together to ensure a better imaging effect.

However, the inventors of the present disclosure have found that in the process of imaging, the light incident from various angles to the lens module is extremely easy to form stray light interference, which has a great influence on the imaging quality of the lens module. At present, although there are measures to block part of stray light by adding a light shading sheet or plate between the optical lenses of the lens module, these measures can only block or absorb part of the stray light. The weakening effect on the overall stray light is relatively small. Good imaging effect of the lens module cannot be guaranteed.

### BRIEF DESCRIPTION OF THE DRAWINGS

Many aspects of the exemplary embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic structural view of a first optical lens according to an embodiment of the present disclosure.

FIG. 2 is a schematic structural view of a second optical lens according to an embodiment of the present disclosure.

FIG. 3 is a schematic structural view of a third optical lens according to an embodiment of the present disclosure.

FIG. 4 is a schematic structural view of a lens module having the first optical lens and the second optical lens according to an embodiment of the present disclosure.

FIG. 5 is a schematic structural view of a lens module having the third optical lens according to an embodiment of the present disclosure.

### DETAILED DESCRIPTION

The present invention will be further illustrated with reference to the accompanying drawings and the embodiments.

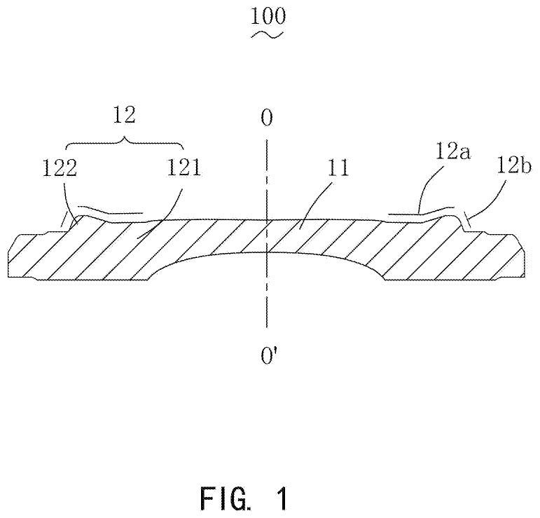

The first embodiment of the present disclosure relates to an optical lens, as shown in FIGS. 1, 2, and 3, including an optical portion 11 located at a central position and configured for optical imaging, and an abutting portion 12 surrounding the optical portion 11 and configured to abut against other optical components. The surface of the abutting portion 12 is provided with a roughened area 12a and a blackened area 12b.

In the present embodiment, the roughened area 12a and the blackened area 12b are disposed on the abutting portion 12 of the optical lens, thereby preventing the roughened area 12a and the blackened area 12b from affecting the optical imaging of the optical portion 11. The roughened area 12a has a roughened surface. Since the light does not form strong specular reflection easily on the roughened surface, when the light is incident on the roughened area 12a, the light is not easily reflected into the reflected stray light which interferes with imaging by the roughened surface. In addition, the blackened area 12b has a black surface, and since the black can absorb more light, when the light is incident on the blackened area 12b, the light is easily absorbed by the blackened surface without forming reflected light, thus reducing the generation of the reflected light. The roughened area 12a and the blackened area 12b disposed on the abutting portion 12 of the optical lens can effectively weaken the reflected stray light incident thereon, thereby improving the imaging quality of the lens module provided with the optical lens.

The implementation details of the present embodiment are specifically described below. The following content is merely intended to facilitate understanding of the provided implementation details, and is not necessary to implement the solution.

In the present embodiment, the optical lens has an optical axis OO′, and includes an optical portion 11 and an abutting portion 12. The optical lens in the present embodiment is an aspherical lens, which can be understood only as an example, and the optical lens may also be a spherical lens.

The optical portion 11 is located at the central position of the optical lens. Generally, the optical axis OO′ of the optical lens passes through the optical portion 11. When the optical lens is assembled in the lens module, the optical portion 11 plays a role of optical imaging.

The abutting portion 12 extends from the optical portion 11 in a direction facing away from the optical axis OO′ and surrounds the optical portion 11. When the optical lens is assembled in the lens module, the abutting portion 12 is generally configured to abut against other optical components, such as a light shading plate, a light shading sheet and a pressure ring.

In the present embodiment, the abutting portion 12 is provided with a roughened area 12a and a blackened area 12b.

The roughened area 12a is an area formed on the surface of the abutting portion 12 by roughening treatment, and can play a role of diffuse reflection rather than specular reflection on the light incident thereon compared with a smooth surface. Therefore, the light incident on the roughened area 12a does not form relatively strong reflected stray light due to the diffuse reflection, thus weakening the reflected stray light which interferes with optical imaging.

The blackened area 12b is an area formed on the surface of the abutting portion 12 by blackening treatment. Since black can absorb more light, the blackened area 12b can absorb a part of the light incident thereon without forming reflected stray light, thus reducing the reflected stray light which interferes with optical imaging.

It is worth mentioning that the “blackening treatment” has many manners, such as black film coating treatment, black material spraying treatment, or black adhesive dispensing treatment, which form a coated blackened area, a sprayed blackened area, and an adhesive-dispensed blackened area respectively. It can be understood that the “blackening treatment” may also be in other manners in addition to the above manners. The “blackening treatment” here is merely an implementation example, and does not limit the present solution in other embodiments. As long as the surface of the optical lens is darkened by the blackening treatment, the blackening treatment is within the protection scope of the solution, and is not enumerated here.

It should be noted that, in the present embodiment, the blackened area may not overlap the roughened area, and may also at least partially overlap the roughened area, which will be separately described below.

When the blackened area 12b does not overlap the roughened area 12a, the blackened area 12b and the roughened area 12a are respectively disposed on the surface of the abutting portion 12. For example, as shown in FIG. 1, the abutting portion 12 of the optical lens 100 includes a connecting portion 121 and an engaging portion 122. The connecting portion 121 is connected to the optical portion 11, and the engaging portion 122 is connected to the connecting portion 121 and extends in a direction facing away from the optical axis OO′. The engaging portion 122 is configured to be engaged with other optical components. The roughened area 12a is disposed on the surface of the connecting portion 121 facing an object side, and the blackened area 12b is disposed on the surface of the engaging portion 122 facing an object side. Further, the roughened area 12a having an extinction action extends from the tail end of the connecting portion 121 close to the optical portion 11 (i.e., the tail end of the aspherical surface) all the way to the front of the engaging portion 122, and the engaging portion 122 is subjected to the blackening treatment, that is, the blackened area 12b is formed. It can be understood that since the surface of the optical lens 100 facing the object side generally faces the light incident side of the lens module, when the roughened area 12a and the blackened area 12b are respectively located on the surfaces of the connecting portion 121 and the engaging portion 122 facing the object side, the roughened area 12a and the blackened area 12b can be advantageously configured to directly weaken the reflected stray light, which affects the optical imaging of the lens module, from the light incident side of the lens module.

When the blackened area 12b does not overlap the roughened area 12a, the blackened area 12b may at least partially overlap the roughened area 12a on the surface of the abutting portion 12.

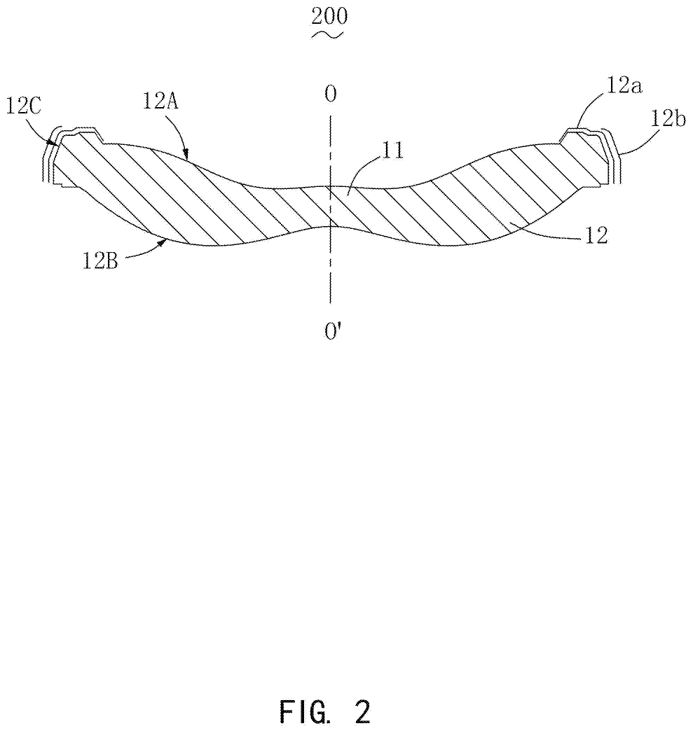

For example, as shown in FIG. 2, the abutting portion 12 of the optical lens 200 includes an object side surface 12A, an image side surface 12B, and a connecting surface 12C. The object side surface 12A is close to the object side, the image side surface 12B is close to the image side, and the connecting surface 12C connects the object side surface 12A with the image side surface 12B. The roughened area 12a is disposed on the object side surface 12A and the connecting surface 12C. The blackened area 12b covers the roughened area 12a on the surface of the connecting surface 12C, that is, the whole blackened area 12b covers the roughened area 12a, and the roughened area 12a is only partially covered by the blackened area 12b. Further, the roughened area 12a having the extinction action extends from the tail end of the object side surface 12A of the abutting portion 12 connected to the optical portion 11 (i.e., the tail end of the aspherical surface) to a boundary between the image side surface 12B and the connecting surface 12C via the connecting surface 12C. That is, the distribution area of the roughened area 12a includes the outer diameter of the optical lens 200 (i.e., the connecting surface 12C). In the optical lens 200, the blackening treatment is performed on the outer diameter portion to form the blackened area 12b.

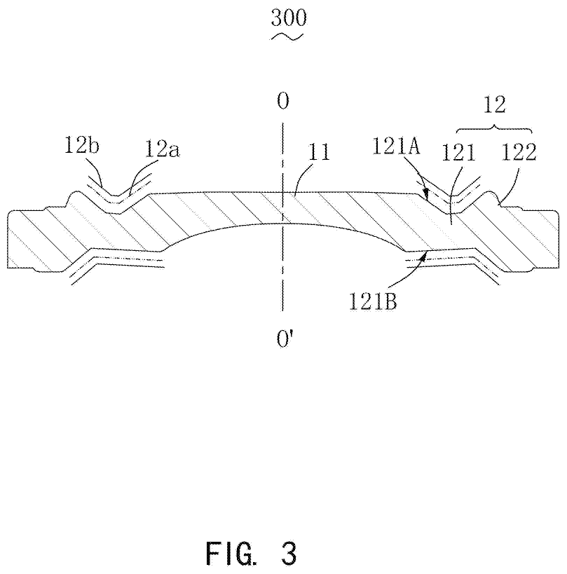

In addition, the blackened area 12b may also completely overlap the roughened area 12a. For example, as shown in FIG. 3, the abutting portion 12 of the optical lens 300 includes a connecting portion 121 and an engaging portion 122. The connecting portion 121 is connected to the optical portion 11, and the engaging portion 122 extends from the connecting portion 121 in a direction facing away from the optical axis OO′ and is configured to be engaged with other optical components. The connecting portion 121 includes an object side surface 121A close to the object side and an image side surface 121B close to the image side. The roughened area 12a is disposed on the object side surface 121A and the image side surface 121B, and the blackened area 12b covers the roughened area 12a, that is, both the blackened area 12b and the roughened area 12a are disposed on the object side and the image side of the optical lens 300. It can be understood that the object side of the optical lens 300 faces towards the light incident side of the lens module, and the image side faces towards an imaging side of the lens module. The blackened area 12b and the roughened area 12a which are disposed on the object side can weaken the reflected stray light from the light incident side to reduce the stray light incident on the imaging side. The blackened area 12b and the roughened area 12a which are disposed on the image side can weaken the stray light nearby the imaging side.

Further, in the optical lens 300, the object side surface 121A and the image side surface 121B of the connecting portion 121 may be partially recessed or partially convex. In the structure shown in FIG. 3, the object side surface 121A is recessed towards the image side surface 121B to form a first groove, the image side surface 121B is recessed towards the object side surface 121A to form a second groove, and the roughened area 12a is disposed on the surfaces of the first groove and the second groove. It is understood that the blackened area 12b covers the roughened area 12a of the first groove and the second groove.

It can be understood that the optical lenses 100, 200, and 300 shown in FIG. 1, FIG. 2, and FIG. 3, and the positions of the blackened area 12b and the roughened area 12a are only examples, and do not limit the solution in other embodiments. In other embodiments, the blackened area 12b and the roughened area 12a may also be disposed in other specific manners, and are not enumerated here.

It should be noted that when the blackened area 12b at least partially overlaps the roughened area 12a, it is necessary to perform extinction treatment, that is the roughening treatment, on the corresponding position (such as the abutting portion 12, or the area outside the effective diameter of the optical lens) of the optical lens (such as the optical lens 200 and the optical lens 300). Then the corresponding blackening treatment (such as the black film coating treatment, the black material spraying treatment and the black adhesive dispensing treatment) is performed on the position where blackening is required. The blackening position may be selected according to actual conditions. For example, the blackened area 12b does not necessarily cover the roughened area 12a completely, which will not be described in detail herein.

It should be noted that the above optical lenses 100, 200, and 300 may be respectively disposed in different lens modules, or may be combined and disposed in the same lens module. For better illustration, the present embodiment lists a schematic structural diagram of two lens modules.

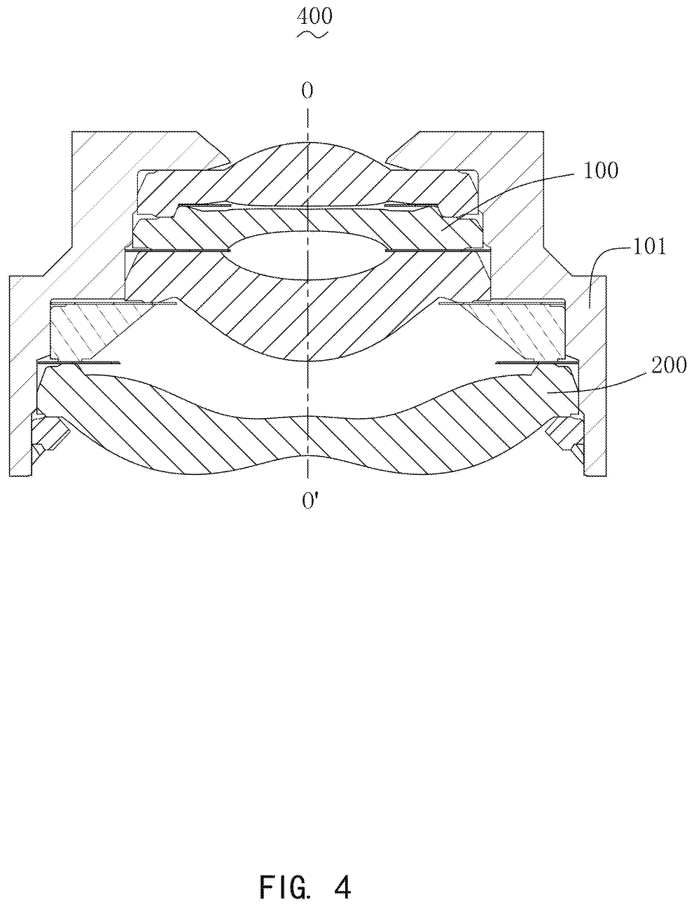

As shown in FIG. 4, the lens module 400 includes a lens barrel 101 and a first optical lens 100 and a second optical lens 200 which are disposed in the lens barrel 101. Specifically, the first optical lens 100 is a lens of the lens module 400 closest to the object side, and the second optical lens 200 is a lens of the lens module 400 closest to the image side. The first optical lens 100 and the second optical lens 200 which are subjected to the extinction treatment and the blackening treatment can effectively reduce the stray light in the lens module 400 and increase the breathability of the lens module.

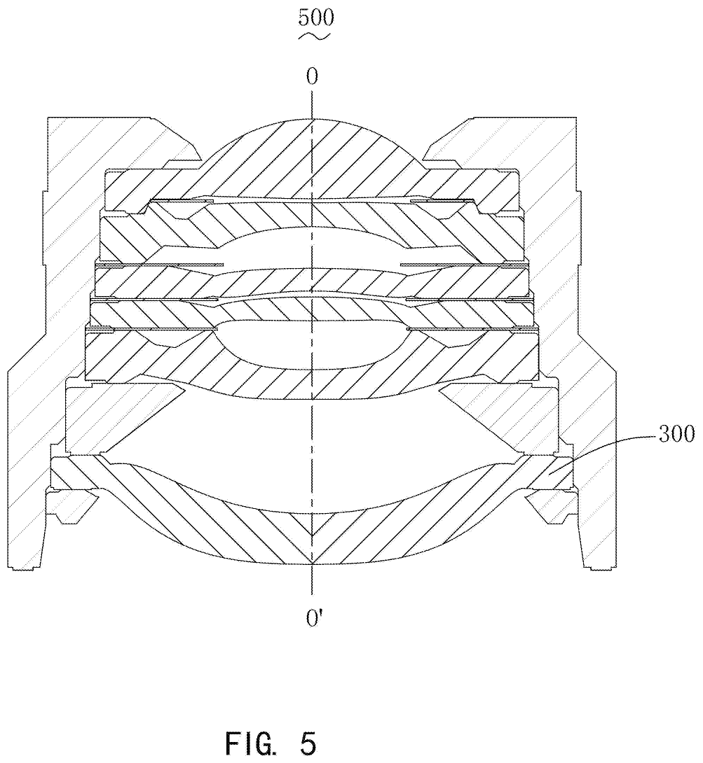

As shown in FIG. 5, the lens module 500 includes an optical lens 300. Specifically, the optical lens 300 is a second lens of the lens module 500 arranged from the object side to the image side. Due to the optical lens 300 subjected to the rough extinction treatment and blackening treatment in sequence, the stray light from the object side and the image side of the lens module 500 is effectively reduced, and the imaging quality of the lens module 500 is improved.

It can be understood that FIG. 4 and FIG. 5 are only application examples of part of optical lenses listed in the solution, and do not constitute limitation to the solution in other embodiments.

Those of ordinary skill in the art can understand that the above embodiments are specific embodiments for implementing the present disclosure. In actual application, various changes can be made in form and detail without departing from the spirit and scope of the present disclosure.

1. An optical lens, comprising:
an optical portion located at a central position and configured for optical imaging; and
an abutting portion surrounding the optical portion and configured to abut against other optical components,
wherein a surface of the abutting portion is provided with a roughened area and a blackened area.

2. The optical lens as described in claim 1, wherein the blackened area does not overlap the roughened area.

3. The optical lens as described in claim 2, wherein the abutting portion comprises a connecting portion connected to the optical portion and an engaging portion extending from the connecting portion in a direction facing away from an optical axis and configured to be engaged with the other optical components, the roughened area is disposed on a surface of the connecting portion facing towards an object side, and the blackened area is disposed on a surface of the engaging portion facing towards the object side.

4. The optical lens as described in claim 1, wherein the blackened area at least partially overlaps the roughened area.

5. The optical lens as described in claim 4, wherein the abutting portion comprises an object side surface close to an object side, an image side surface close to an image side, and a connecting surface connecting the object side surface with the image side surface, the roughened area is disposed on the object side surface and the connecting surface, and the blackened area covers a part of the roughened area on the connecting surface.

6. The optical lens as described in claim 4, wherein the abutting portion comprises a connecting portion connected to the optical portion, and an engaging portion extending from the connecting portion in a direction facing away from an optical axis and configured to be engaged with the other optical components, the connecting portion comprises an object side surface close to an object side and an image side surface close to an image side, the roughened area is disposed on the object side surface and the image side surface, and the blackened area covers the roughened area.

7. The optical lens as described in claim 6, wherein the object side surface is recessed towards the image side surface to form a first groove, the image side surface is recessed towards the object side surface to form a second groove, and the roughened area is disposed on surfaces of the first groove and the second groove.

8. The optical lens as described in claim 2, wherein the blackened area is one of a coated blackened area, a sprayed blackened area, and an adhesive-dispensed blackened area.

9. A lens module, comprising:
a lens barrel; and
the optical lens according to claim 1 received in the lens barrel.
